(19) United States
(12) Patent Application Publication
(10) Pub. No.: US 2007/0116846 A1
(43) Pub. Date: May 24, 2007

(54) Flour formulations for making gluten-free food products

(76) Inventor: Aquah Moira Singh-Meneghini, Forest Hills, NY (US)

Correspondence Address: THELEN REID BROWN RAYSMAN & STEINER LLP, 900 THIRD AVENUE, NEW YORK, NY, 10022, US

(21) Appl. No.: 11/285,862

(22) Filed: Nov. 22, 2005

(51) Int. Cl. A21D 13/04

(52) U.S. Cl. 426/550

(57) ABSTRACT

The invention provides a gluten-free flour formulation containing a plurality of ingredients. Each ingredient in the formulation is substantially or completely free of gluten protein. In one embodiment, the formulation meets the requirements for kosher certification. The gluten-free flour formulation includes at least two ingredients of the following: ground or partially ground particles of dried roots of a root-tuber crop, dried kernels or nuts of a nut-tree and dried fruits of a species in the Musaceae family. In some embodiments, the gluten-free flour formulation includes ground or partially ground particles of dried cassava root, almond nuts and dried plantain fruits, wherein the proportions of the ground cassava root, almond nuts and dried plantain fruits range from about 15% to about 85%, from about 20% to about 60%, and from about 5% to about 30%, respectively.

### FIELD OF THE INVENTION

The invention is directed to novel flour formulations and methods for making food products, particularly gluten-free food products, using such novel flour formulations.

### BACKGROUND OF THE INVENTION

Gluten is the name given to a group of seed storage proteins found in wheat, rye, barley and possibly oats. The presence of gluten in the diet causes celiac disease, an autoimmune condition stemming from genetic and environmental factors, which could result in damage to the villi of the intestinal wall, which in turn may contribute to the development or onset of a wide range of other health issues, including malabsorption, gastrointestinal conditions, and cancer (particularly if untreated). According to the Celiac Sprue Association, approximately 1 in 133 people have celiac disease, however, only about 3% of these have been diagnosed. It appears that there are over 2.1 million undiagnosed people with celiac disease in the United States. The prevalence of celiac disease has been recognized as greater in women suffering from infertility. Dermatitis herpetiformis, a severely pruritic and blistering cutaneous disease, is another condition often associated with ingestion of gluten.

Despite a good deal of research, the precise role of gluten in connection with certain diseases, as well as a cure for diseases associated with the ingestion of gluten, are not known. A gluten-free diet is mandated for people who are diagnosed with celiac disease or dermatitis herpetiformis.

Furthermore, approximately 12% of the general population is believed to suffer from gluten sensitivity. This sector, combined with those suffering from celiac disease, may manifest as a broad panorama of autoimmune diseases, as well as neurological diseases, and lymphoma. Gluten ataxia, with pronounced presence amongst the pediatric population, is considered by many experts to be the most common form of neurological manifestation of atypical celiac disease, which has been correlated with pre-senile dementia.

Gluten allergy sufferers may also be advised to follow a gluten-free diet. A gluten-free diet may also be recommended to individuals suffering from irritable bowel syndrome, autism, attention deficit hyperactivity disorder (ADHD), depression, dental enamel defects (DEDs), osteoporosis, and other health problems.

The aforementioned conditions affect a large cross-section of the world's population. Thus, there is a need for a dietary alternative incorporating gluten-free foodstuffs.

A gluten-free diet involves avoiding foods made from, or otherwise containing, wheat, rye, barley and oats. Avoiding these grains, or their processed forms, in making food products is a challenge to food manufacturers, especially to bakers, because eliminating any of these grains eliminates the gluten source and, as a result, provides an unacceptable raise-structure or raise-volume to bakery products. Gluten, in flours made from these grains, acts as a structure-enhancing or volume-enhancing component during baking due to its cohesive, elastic and viscous properties, and thus gluten is important to the extensibility, resistance to stretch, mixing tolerance and gas-holding ability of the dough. Accordingly, in order to prepare a bakery product without any of the gluten containing grains mentioned above, a baker has to identify a gluten alternative, or gluten-free ingredient, exhibiting acceptable elastic and viscous properties in dough so that the resulting baked product will have an acceptable raise-structure and volume.

There is also a need to address the taste factor, because virtually the entire population associates a particular flavor with most food products that normally contain gluten (bread and cereals for example). However, the removal of gluten and the incorporation of a necessary substitute usually results in an unfamiliar and inferior taste, as well as a deficiency in overall quality.

Rice and maize flours are gluten-free ingredients and have high amounts of easily digestible carbohydrates, which are desirable for special diets. However, these ingredients do not possess acceptable elastic and viscous properties, and result in a liquid bread batter, rather than dough. Also, the final baked bread or other goods prepared from these ingredients may have a high-density, a crumbly or sandy texture, poor color, and a distinguishably different taste relative to the normal taste of bread or other gluten-free goods in which such flours are found.

Root-tuber flours such as cassava and sweet potato flours are gluten free. Unlike rice and maize, root-tuber flours provide volume, and crust and crumb textures which are acceptable for making bakery products. However, a bakery product prepared solely from a root-tuber flour provides undesirable sensory qualities, such as taste, mouth-feel or palatability.

In existing methods of making gluten-free bakery products, raw materials and their flours, such as rice, maize, soy, potato or buckwheat (a grain distinguishable from wheat and not containing gluten) are mixed with other ingredients to provide volume and texture, and a variety of specially manufactured gluten-free bakery products available in the market are made from such mixtures. However, none of the existing gluten-free mixtures provide a combination of taste, mouth-feel, crumb and crust textures, volume and shelf-life, similar to, or as good as, the food prepared from gluten containing ingredients. There exists a need to develop a gluten-free formulation for making a food which will have characteristics similar to, or otherwise as good as, the food prepared from gluten containing ingredients. In addition, none of the existing gluten-free mixtures provide a combination of taste, mouth-feel, crumb and crust textures, volume and shelf-life acceptable to consumers. Accordingly, there also exists a need to develop various kinds of gluten-free formulations for diverse consumer preferences.

Furthermore, a specific group of consumers may prefer a specific type of gluten-free food for reasons not related to health. For example, Jewish consumers and others following Jewish dietary law may prefer kosher food. During the Jewish holiday Passover, these consumers abstain from eating and processing any food product that contains “chometz” ingredients such as wheat (with the exception of wheat-containing matzos), barley, oats, spelt or rye. Also forbidden during Passover are “kitniyot” ingredients, such as rice, beans or peanuts. Accordingly, there is a need to develop a gluten free formulation that is free from chometz and kitniyot ingredients. In addition, certain kosher certified products exclude dairy-based ingredients, and these products are generally known as “parve or pareve” products. Accordingly, there is also a need to develop a gluten-free formulation that would qualify as “parve or pareve.” Products which qualify as “parve or pareve” would provide a viable and beneficial addition to those existing foods fitting Jewish dietary rule.

A historical religious dietary practice is associated with non-Passover days, during which members of the Jewish faith would seek to abstain from eating spring wheat because spring wheat is not considered kosher. Since determining whether wheat sold in grocery stores is spring wheat is difficult, non-wheat food formulations would provide a viable alternative.

Additionally, consumers, regardless of their health condition or faith, are constantly looking for various food choices, as well as alternatives to goods containing processed flours, such as wheat flours, which have limited nutritional value, unless fortified.

For the reasons discussed above, there exists a need to develop various kinds of gluten-free food formulations.

### SUMMARY OF THE INVENTION

The present invention provides a flour formulation containing a plurality of ingredients. In some embodiments of the invention, the plurality of ingredients includes two or more flours selected from a group comprising a root-tuber flour, a nut flour, a musa-fruit flour and a buckwheat flour.

Each ingredient in the formulation is substantially free of gluten protein. In some embodiments of the invention, each ingredient in the formulation meets the requirements for kosher certification.

According to one embodiment of the invention, the flour formulation includes at least two ingredients, wherein the first ingredient is a root-tuber flour and the second ingredient is a nut flour. In some embodiments, the proportions of root-tuber and nut flours in the formulation range from about 15% to about 85% and from about 15% to about 85%, respectively, by weight of the total combined weight of both root-tuber and nut flours.

According to another embodiment of the invention, the flour formulation includes at least two ingredients, wherein the first ingredient is a root-tuber flour and the second ingredient is a musa-fruit flour. In some embodiments, the proportions of root-tuber and musa-fruit flours range from about 50% to about 95% and from about 5% to about 50%, respectively, by weight of the total combined weight of both root-tuber and musa-fruit flours.

According to another embodiment of the invention, the flour formulation includes at least three ingredients, wherein the first ingredient is a root-tuber flour, the second ingredient is a nut flour, and the third ingredient is a musa-fruit flour. In some embodiments, the proportions root-tuber, nut, and musa-fruit flours range from about 15% to about 75%, from about 25% to about 60%, and from about 5% to about 25%, respectively, by weight of the total combined weight of root-tuber, nut, and musa-fruit flours.

According to another embodiment of the invention, the flour formulation includes at least four ingredients, wherein the first ingredient is a root-tuber flour, the second ingredient is a buckwheat flour, the third ingredient is a nut flour, and the fourth ingredient is a musa-fruit flour. In some embodiments, the proportions of root-tuber, buckwheat, nut, and musa-fruit flours range from about 15% to about 75%, from about 15% to about 75%, from about 25% to about 60%, and from about 5% to about 25%, respectively, by weight of the total combined weight of root-tuber, buckwheat, nut and musa-fruit flours.

The flour formulation may be used for making gluten-free food products. Also, the flour formulation may be used for making kosher food products. In some embodiments, the flour formulation may be used for making Passover specific kosher food products. In other embodiments, the flour formulation may be used for making “parve or pareve” kosher products that exclude dairy ingredients. In one embodiment, the flour formulation may be used for making sugar-free, reduced sugar, low-carbohydrate snacks, sweets and foods.

The flour formulation may be used for various types of cooking, including for example, baking, roasting, broiling, grilling, frying, boiling, simmering, steaming, as well as in soups and porridges, and thus may be used for making various types of cooked food products. The flour formulation may also be used for making various types of uncooked food products, for example, ready-to-serve food products, by mixing with sugar, water, juice, purees, milk or other suitable ingredients.

According to one aspect of the invention, the flour formulation provides a combination of desirable baking qualities, including crumb and crust textures, volume, shelf-life and sensory qualities, including taste and mouth-feel. Desirable combinations of baking and sensory qualities may be determined based on the acceptability of the baked products to a specific group of consumers. A ratio of a plurality of flour ingredients in the formulation provides the combination of desirable baking and sensory qualities. At least one ingredient in the formulation provides the baking qualities by providing elastic and viscous properties to the dough, and at least one other ingredient in the formulation provides the sensory qualities.

The invention also provides various dry gluten-free bakery products including cookies, cakes, pancakes, breads and breading and wet gluten-free products including refrigerated or frozen dough and pre-made but uncooked dough, prepared from the flour formulation, as well as batters and coatings for frying and baking, for example.

The invention further provides methods for making or otherwise manufacturing gluten-free and kosher food products using the flour formulation.

Additional aspects of the present invention will be apparent in view of the detailed description, which follows.

### DETAILED DESCRIPTION OF THE INVENTION

The term “gluten,” as used herein, refers to a group of seed storage proteins that are known to cause celiac and other diseases. These proteins are known as gliadin in wheat, hordein in barley and secalin in rye.

The term “gluten-free,” as used herein, means the total content of gluten in a product does not exceed about 200 ppm of the total dry matter in the product. The present invention provides a gluten-free flour formulation containing a plurality of gluten-free ingredients. In one embodiment, the gluten content in the formulation is less than or equivalent to about 200 ppm. In another embodiment, the gluten content in the formulation is less than or equivalent to about 20 ppm. In yet another embodiment, the formulation contains no gluten and thus the formulation is 100% gluten-free. In some embodiments, the gluten content in the formulation is in accordance with the rules of regulatory or certifying organizations (e.g., FDA, Codex Alimentarius).

The term “kosher food,” as used herein, means food made, sold and served in accord with the dietary laws of the Jewish faith. Each ingredient in the gluten-free formulation meets the requirements of any or all of the kosher certifying organizations known to one skilled in the art. Passover is the time of year when some Jewish consumers are particularly careful about what they eat, due to the strict prohibitions relating to eating chometz ingredients such as wheat, barley, oats, spelt or rye. Accordingly, in one embodiment, the gluten-free formulation is free from any of the chometz ingredients. In addition, some American Jewish consumers do not use kitniyot ingredients such as legumes (including soy, peanuts, and peas), corn, rice and mustard flour. Accordingly, in another embodiment, the gluten-free formulation is free of any kitniyot ingredients. In some embodiments, the gluten-free formulation excludes dairy-based products such as milk and butter in order to qualify as a “parve or pareve” kosher product.

The flour formulation of the invention includes at least two flour ingredients selected from a group comprising a root-tuber flour, a nut flour, a musa-fruit flour and a buckwheat flour.

Root-tuber flour is prepared by pulverizing dried roots of a root-tuber crop or its related species. Examples of a root-tuber crop include, but not limited to, cassava (Manihot esculenta), sweet potato (Ipomoea batatas), yam (Diascorea sp.) and taro (Colocasia esculenta). Accordingly, a root-tuber flour includes, but is not limited to, cassava flour, sweet potato flour, yam flour and taro flour.

In one embodiment, the whole root including the outer skin, woody ends, inner core and other fibrous non-farinaceous (starch rich) portions are used for pulverizing. In another embodiment, the root, trimmed of its outer skin, woody ends, and inner core is used for pulverizing. In some embodiments, starch flour, chemically processed from the roots, is used as an ingredient instead of the flour mechanically pulverized from the dried roots.

In a preferred embodiment, the root-tuber flour is a cassava flour, mentioned above. Cassava is also known as manioc, mandioca, yucca (yucca of the Euphorbiaceae family, not of the Agavaceae family), yucca root, Brazilian arrowroot, and manioca fritta.

Nut flour is prepared by pulverizing the dry nut or kernel, removed from the mature or partially mature fruit of a nut tree, or its related species. Examples of nut trees include, but is not limited to, almond (Prunus dulsis), hazelnut (Corylus sp.), walnut (Juglans sp.), pecan (Carya sp.), pistachio (Pistacia vera L.), cashew (Anacardium occidentale L.), and macadamia (Macadamia sp.). Accordingly, a nut flour includes, but is not limited to, almond flour, hazelnut flour, walnut flour, pecan flour, pistachio flour, cashew flour and macadamia flour.

Musa-fruit flour is prepared by pulverizing dried fruits of a herbaceous tree species in the Musaseae family. Examples of a herbaceous tree species in the Musaseae family include, but are not limited to, plantain (Musa paradisiaca L.) and banana (Musa sapientum L.). Plantain, as used herein, is a large, tropical, treelike herb, botanically related to and resembling a banana, and bearing similar fruit. Unlike bananas, plantains are not readily edible and should be cooked before eating. Cooked plantains are a staple in tropical regions as well as a recognized export product. Examples of a musa-fruit flour include, but are not limited to, plantain flour and banana flour.

Buckwheat (Fagopyrum esculentum) is a plant in the family Polygonaceae and is botanically unrelated to wheat (Triticum sp.). Buckwheat flour is prepared by pulverizing the seeds of buckwheat plant.

In some embodiments, the flours are a fine powder. In other embodiments, they consist of coarse flour or flour granules. In one embodiment each of the raw materials is pulverized individually, and two or more of such individually pulverized ingredients are mixed together. In another embodiment two or more of the raw materials are pooled and mixed together, and the mixed raw materials pulverized together.

According to one embodiment of the invention, the flour formulation includes a root-tuber flour and a nut flour. In one embodiment, the proportions of root-tuber and nut flours in the formulation range from about 15% to about 85% and from about 15% to about 85%, respectively, by weight of the total combined weight of both root-tuber and nut flours. The ratio of root-tuber and nut flours in the formulation ranges between 0.15:0.85 and 0.85:0.15 parts by weight. In another embodiment, the proportions of root-tuber and nut flours range from about 50% to about 70% and from about 30% to about 50%, respectively, by weight of the total combined weight of both root-tuber and nut flours, and the ratio of root-tuber and nut flours in the formulation ranges between 0.50:0.50 and 0.70:0.30 parts by weight. In yet another embodiment, the relative proportion of root-tuber flour is about 15%, 18%, 25%, 30%, 33%, 50%, 60%, 63%, 70% or 75% and of nut flour is about 15%, 18%, 25%, 30%, 33%, 50%, 60%, 63%, 70% or 75%. The flour formulation containing a root-tuber flour and a nut flour may include one of the following combinations: a cassava flour and an almond flour; a sweet potato flour and an almond flour; a cassava flour and a hazelnut flour; and a sweet potato flour and a hazelnut flour.

According to another embodiment of the invention, the flour formulation includes a root-tuber flour and a musa-fruit flour. In one embodiment, the proportions of root-tuber and musa-fruit flours range from about 50% to about 95% and from about 5% to about 50%, respectively, by weight of the total combined weight of both root-tuber and musa-fruit flours. The ratio of root-tuber and musa-fruit flours in the formulation ranges between 0.50:0.50 and 0.95:0.05 parts by weight. In another embodiment, the proportions of root-tuber and musa-fruit flours range from about 60% to about 80% and from about 20% to about 40%, respectively, by weight of the total combined weight of both root-tuber and musa-fruit flours, and the ratio of root-tuber and musa-fruit flours in the formulation ranges between 0.60:0.40 and 0.80:0.20 parts by weight. In yet another embodiment, the relative proportion of root-tuber flour is about 50%, 60%, 63%, 70%, 75%, 80%, 85% or 90% and of musa-fruit flour is about 5%, 10%, 15%, 18%, 20%, 25% or 50%. The flour formulation containing a root-tuber flour and a musa-fruit flour may include one of the following combinations: a cassava flour and a plantain flour; a sweet potato flour and a plantain flour; a cassava flour and a banana flour; and a sweet potato flour and a banana flour.

According to yet another embodiment of the invention, the flour formulation includes three or more ingredients, including a root-tuber flour, a nut flour, and a musa-fruit flour. In one embodiment, the proportions of root-tuber, nut, and musa-fruit flours range from about 15% to about 85%, from about 20% to about 80%, and from about 5% to about 33%, respectively, by weight of the total combined weight of root-tuber, nut and musa-fruit flours. The ratios of root-tuber, nut and musa-fruit flours in the formulation are 0.15-0.85:0.20-0.80:0.05-0.33 parts by weight respectively. In another embodiment, the proportions of root-tuber, nut, and musa-fruit flours range from about 35% to about 65%, from about 40% to about 50%, and from about 10% to about 20%, respectively, by weight of the total combined weight of root-tuber, nut and musa-fruit flours, and the ratios of root-tuber, nut and musa-fruit flours in the formulation are 0.35-0.65:0.40-0.50:0.10-0.20 parts by weight respectively. In yet another embodiment, the relative proportion of root-tuber flour is about 15%, 18%, 20%, 25%, 30%, 33%, 40%, 50%, 60%, 70% or 75%, of nut flour is about 25%, 30%, 33%, 50%, 60%, 70% or 80% and of musa-fruit flour is about 5%, 10%, 15%, 18%, 20%, 25%, 30% or 33%. The flour formulation containing a combination of root-tuber, nut and a musa-fruit flour may include at least one of the root-tuber flours, at least one of the nut flours, and at least one of the musa-fruit flours discussed above.

In one example, the flour formulation contains root-tuber, nut and musa-fruit flours, and includes, in combination, a cassava flour, an almond flour, and a plantain flour. In one embodiment, the proportions of cassava, almond, and plantain flours range from about 15% to about 85%, from about 20% to about 80%, and from about 5% to about 33%, respectively, by weight of the total combined weight of cassava, almond and plantain flours. The ratios of cassava, almond and plantain flours in the formulation are 0.15-0.85:0.20-0.80:0.05-0.33 parts by weight respectively. In another embodiment, the proportions of cassava, almond, and plantain flours range from about 35% to about 65%, from about 40% to about 50%, and from about 10% to about 20%, respectively, by weight of the total combined weight of cassava, almond and plantain flours, and the ratios of cassava, almond and plantain flours in the formulation are 0.35-0.65:0.40-0.50:0.10-0.20 parts by weight respectively. In yet another embodiment, the relative proportion of cassava flour is about 15%, 18%, 20%, 25%, 30%, 33%, 40%, 50%, 60%, 70% or 75%, of nut flour is about 25%, 30%, 33%, 50%, 60%, 70% or 80%, and of plantain flour is about 5%, 10%, 15%, 18%, 20%, 25%, 30% or 33%.

In another example, the flour formulation contains one or more root-tuber flours, one or more nut flours and two or more musa-fruit flours. In one embodiment, the flour formulation includes, in combination, a cassava flour, an almond flour, a plantain flour, and a banana flour. In one embodiment, the proportions of cassava, almond, plantain, and banana flours range from about 15% to about 85%, from about 20% to about 80%, from about 5% to about 33%, and from about 5% to about 33%, respectively, by weight of the total combined weight of cassava, almond, plantain, and banana flours. The ratios of cassava, almond, plantain, and banana flours in the formulation are 0.15-0.85:0.20-0.80:0.05-0.33; 0.05-0.33 parts by weight respectively. In another embodiment, the proportions of cassava, almond, plantain, and banana flours range from about 35% to about 65%, from about 40% to about 50%, from about 10% to about 20%, and from about 10% to about 20%, respectively, by weight of the total combined weight of cassava, almond, plantain, banana flours, and the ratios of cassava, almond, plantain, and banana flours in the formulation are 0.35-0.65:0.40-0.50:0.10-0.20:0.10-0.20 parts by weight respectively. In yet another embodiment, the relative proportion of cassava flour is about 15%, 18%, 20%, 25%, 30%, 33%, 40%, 50%, 60%, 70% or 75%, of nut flour is about 25%, 30%, 33%, 50%, 60%, 70% or 80%, of plantain flour is about 5%, 10%, 15%, 18%, 20%, 25%, 30% or 33%, and of banana flour is about 5%, 10%, 15%, 18%, 20%, 25%, 30% or 33%.

According to yet another embodiment of the invention, the flour formulation includes four or more ingredients, including a root-tuber flour, a buckwheat flour, a nut flour, and a musa-fruit flour. In one embodiment, the proportions of root-tuber, buckwheat, nut, and musa-fruit flours range from about 5% to about 85%, from about 5% to about 85%, from about 20% to about 80%, and from about 5% to about 33%, respectively, by weight of the total combined weight of root-tuber, buckwheat, nut and musa-fruit flours. The ratios of root-tuber, buckwheat, nut and musa-fruit flours in the formulation are 0.05-0.85:0.05-0.85:0.20-0.80:0.05-0.33 parts by weight respectively.

In another embodiment, the proportions of root-tuber, buckwheat, nut, and musa-fruit flours range from about 20% to about 65%, from about 20% to about 65%, from about 40% to about 50%, and from about 10% to about 20%, respectively, by weight of the total combined weight of root-tuber, buckwheat, nut and musa-fruit flours, and the ratios of root-tuber, buckwheat, nut and musa-fruit flours in the formulation are 0.20-0.65:0.20-0.65:0.40-0.50:0.10-0.20 parts by weight respectively.

In yet another embodiment, the relative proportion of root-tuber flour is about 15%, 18%, 20%, 25%, 30%, 33%, 40%, 50%, 60%, 70% or 75%, of buckwheat flour is about 15%, 18%, 20%, 25%, 30%, 33%, 40%, 50%, 60%, 70% or 75%, of nut flour is about 25%, 30%, 33%, 50%, 60%, 70% or 80% and of musa-fruit flour is about 5%, 10%, 15%, 18%, 20%, 25%, 30% or 33%. The flour formulation containing a combination of root-tuber, buckwheat, nut and musa-fruit flours includes at least one of the root-tuber flours, buckwheat flour, at least one of the nut flours, and at least one of the musa-fruit flours discussed above.

According to one aspect of the invention, the flour formulation provides a combination of baking qualities including crumb and crust textures, volume, and shelf-life, and sensory qualities, including taste and mouth-feel to the baked products. The combination of baking and sensory qualities is determined based on the acceptability of the baked products to a specific group of consumers, for example, consumers having celiac disease, or those otherwise seeking dietary alternatives to gluten-containing food stuffs. The ratios of flour ingredients in the formulation provide the acceptable combination of baking and sensory qualities. These qualities are unique for a specific food product. The relative proportion of each ingredient in the combination of ingredients provides the unique qualities of the product. For example, in one embodiment, an approximate ratio of 1.00:0.53:0.19 (e.g., 154 gms:83 gms:30 gms) of cassava, almond and plantain flours is used for preparing a gluten-free chocolate-chip cookie. In another embodiment, an approximate ratio of 1.00:0.40:0.26 (e.g., 190 gms:75 gms:50 gms) of sweet potato, almond and plantain flours is used for preparing a gluten-free chocolate-chip cookie.

In one embodiment, an approximate ratio of 1.00:2.00:0.75 (e.g., 88 gms:176 gms:66 gms) of cassava, almond and plantain flours is used for preparing a gluten-free carrot cup cake. In another embodiment, an approximate ratio of 1.00:1.50:0.75 (e.g., 100 gms:150 gms:75 gms) of cassava, hazelnut and plantain flours is used for preparing a gluten-free carrot cup cake.

Cassava flour in the formulation provides elastic and viscous dough properties, and almond flour and/or plantain flour provides qualities such as taste.

In some embodiments, the flour formulation is used to make, or otherwise manufacture, low fat, low sugar and/or low carbohydrate food products. The proportion of ingredients in the formulation is adjusted to make various types of low fat, low sugar and/or low carbohydrate food products. For example, a lower proportion of cassava or plantain flour is selected to produce a low carbohydrate product, and a lower proportion of almond flour is selected to produce a low fat product. In one embodiment, a cake or cookie prepared using the formulation includes, for example, about 1% to about 10% total carbohydrate, about 0% to about 15% total fat, and about 3% to about 10% total protein.

In one embodiment, the flour formulation may be combined with one or more sweeteners or other sugar additives known to one skilled in the art for making a sugar-free food product. In some embodiments, the flour formulation may be combined with maple sugar instead of cane sugar or beet sugar to make a sugar-flavored, generally sweetened food product.

In some embodiments, the food prepared using the formulation is in solid form (e.g., cookies, cakes). In other embodiments, the food prepared using the formulation is in colloidal or semi-liquid form (e.g., a cream, or a shake).

The flour formulations may be suitable for various types of cooking including, for example, baking, roasting, broiling, grilling, frying, boiling, simmering and steaming, and thus may be used for making various types of cooked food products, including, for example, but not limited to cookies, cakes, pancakes, dumplings, wafers, doughnuts, brownies, fritters, chips, and puff pastry (with or without filling).

The flour formulations may also be suitable for making various types of uncooked food products, for example, ready-to-serve food products, by mixing with other gluten-free ingredients such as, for example, sugar, fruit or vegetable purees, yoghurt, milk or cream, or water. Examples of uncooked food products include, but are not limited to, liquid drinks, shakes and frappes, creams (for fillings, toppings or base), custards, tarts, puddings, spreads, sauces, cereals or porridges, yogurts and other chilled or un-chilled desserts. In one embodiment, the flour formulation may be used as a layering component for a sandwiched food product, which uses for example, ice creams or yogurts. In some embodiments, each ingredient in the formulation may be used as a component for different layers in a sandwich.

The flour formulations may also be used as food additives, for example, thickeners, coatings, color-enhancers, taste enhancers, texture enhancers, ice cream additives or other additives, including wet batter and dry breading as meat or vegetable coatings, for example.

The flour formulations may also be suitable for making various types of partially cooked food products.

The invention provides, in addition to various dry, gluten-free bakery products, for example, cookies, cakes, and breads, wet gluten-free products, refrigerated or frozen dough (e.g., cylindrical refrigerated dough) and pre-made but uncooked dough, prepared from the flour formulation.

The following examples are intended for illustration purposes only, and should not be construed as limiting the scope of the invention in any way.

### EXAMPLES

### Example 1

Gluten-Free Cookie

Ingredients for making 15-20 cookies:

| Cassava flour | 154 | gms (1 and ½ cups) |
|---|---|---|
| Almond flour | 83 | gms (⅔ cup) |
| Plantain flour | 30 | gms (¼ cup) |
| Butter | 113 | gms |
| Sugar | 160 | gms |
| Baking powder | 10 | gms |
| Egg | 1 (approximately 43-50 gms) | |
| Nutmeg | ⅛ | tsp |
| Chocolate chips | 110 | gms |
| Cinnamon | | |

Method:

Cassava, almond and plantain flours are mixed together. The flour mixture, baking powder and any flavoring agent are sifted into a bowl. Butter is added, followed by the sugar. The egg is added to make a dough. The dough is shaped or otherwise prepared to form a cookie as per the preparations known to one skilled in the art, and then baked in a preheated oven for 20 minutes, at 325-350 F.°.

| Gluten Content | | |
|---|---|---|
| Gluten | 0 | ppm |
| Nutrient Content | | |
| Calories | 114 | |
| Calories from Fat | 45 | |
| Total Fat | 5 | gm |
| Total Carbohydrate | 15 | gm |
| Protein | 2 | gm |

| | |
|---|---|
| Vitamin A | 3% |
| Calcium | 3% |
| Iron | 2% |

### Example 2

Gluten-Free Carrot Cupcakes

Ingredients for 10-13 cupcakes:

| Cassava flour | 88 | gms |
|---|---|---|
| Almond flour | 176 | gms |
| Plantain flour | 65 | gms |
| Butter | 113 | gms |
| Baking powder | ½ | teaspoon (13 gms) |
| Nutmeg | ½ | teaspoon |
| Cinnamon | 1 | teaspoon (3 gms) |
| Banana | 1 | |
| Raisins | 55 | gms |
| Shredded carrots | 56 | gms |
| Egg | 2 | |
| Light Brown Sugar | 250 | gms (1 and 2/3 cup) |

Method

The ingredients are mixed and stirred well. Shredded carrots are added. The mixture is poured into a non-stick cupcake pan and baked for 35 minutes at about 300 F.°.

| Gluten Content | | |
|---|---|---|
| Gluten | 0 | ppm |
| Nutrient Content in Each Cupcake | | |
| Calories | 223 | |
| Calories from Fat | 88 | |
| Total Fat | 10 | gm |
| Total Carbohydrate | 29 | gm |
| Protein | 5 | gm |

| | |
|---|---|
| Vitamin A | 18% |
| Vitamin C | 2% |
| Calcium | 8% |
| Iron | 4% |

### Example 3

Cream Puffs

Ingredients:

18 oz water
7 oz butter
4 oz almond flour
8 oz cassava flour
3 oz plantain flour
½ tsp. baking powder
7 whole eggs
   Method

Water is boiled and butter is added. The flours are mixed, added to the water containing butter, heated for 5 minutes, and cooled. One egg at a time is added and mixed into the cooled mixture. The mixture is then baked at 375 degrees Fahrenheit for 15 minutes. The baked product will be light brown and rather lightweight and airy.

### Example 4

Pastry Cream

Ingredients:

2 quarts milk
2 cups cream
8 oz butter
12 oz sugar
2 tsp vanilla extract
8 whole eggs
8 oz sugar
8 oz cornstarch
   Method

Milk, cream, butter and 12 oz sugar and vanilla extract are heated together until boiling is reached. Eggs, 8 oz. sugar and corn starch are mixed and added to the boiling mixture, cooked for 5 minutes and cooled. The custard, or filling may be injected into cream puffs.

### Example 5

Almond Cream

Ingredients:

9 oz sugar
9 oz soft butter
4 whole eggs
1 tsp. vanilla extract
7 oz almond flour
1 oz cassava flour
2 oz plantain flour
   Method

Sugar and butter are mixed together. Eggs and vanilla extract are added to the sugar/butter mixture. The flours are mixed together and added to the mixture. This almond cream can be used for making almond tarts, or for making almond “biscuits.” For making almond tarts, the mixtures are shaped accordingly and baked at 325 degrees Fahrenheit. For making flat almond “biscuits” (French-style cookies, or even tuilles), the mixtures are rolled and shaped accordingly and baked at 325 degrees Fahrenheit.

### Example 6

Sweet Paste

Ingredients:

10 oz soft butter
6 oz confectioners sugar
5 oz almond flour
10 oz cassava flour
5 oz plantain flour
2 whole eggs
1 lemon peel
1 tsp. lemon extract
1 tsp. almond extract
   Method

This sweet paste can be used for making tart shells. Butter, sugar, and flour are mixed together. Eggs, lemon peel, lemon extract, and almond extract are mixed together and added to the butter, sugar, flour mixture, until dough (paste) forms.

### Example 7

Sable (a type of cookie)

Ingredients:

9 oz soft butter
7 oz sugar
4 oz egg yolks
2 oz milk
1 tsp. vanilla
1 tsp. almond extract
1 tsp. lemon extract
6 oz. Almond flour
8 oz. Cassava flour
4 oz. Plantain flour
   Method

Butter and sugar are mixed together. Egg yolks, milk, vanilla, almond extract, and lemon extract are mixed together and added to the previous mixture. Almond, cassava and plantain flours are mixed together and folded into the mixture. Cookies are prepared from this mixture.

### Example 8

Sponge Cake

Ingredients:

10 egg whites
10 egg yolks
13 oz confectioners (powdered) sugar
1 tsp. vanilla extract
1 tsp. lemon extract
1 tsp. almond extract
5 oz. Cassava flour
5 oz. Plantain flour
2 oz. Almond flour
1 tsp. baking powder
   Method

Sponge cake may be prepared as a cake, or for use in other desserts or foods requiring a gluten-free cake, as in gluten-free ladyfingers. Egg whites are whipped well until they are foamy or creamy. Egg yolks, confectioners (powdered) sugar, vanilla extract, lemon extract, almond extract are whipped together and added to the egg white. Cassava, almond, and plantain flours, and baking powder are mixed together and added to the previous mixture. The final mixture is baked at 350 degrees Fahrenheit for 20 minutes and cooled. After it is cool, the sponge cake may be cut according to preference.

### Example 9

Banana Fritters/Doughnuts

Ingredients:

125 grams cassava flour
75 grams plantain flour
50 grams almond flour
50 grams sugar (sugar or portion thereof are optional)
5 tsp. baking powder
1 tsp. nutmeg
1 egg
1 banana, ripened
1 tbsp. oil (eg. olive oil)
   Method:

Cassava, almond and plantain flours, sugar, baking powder, and nutmeg are mixed together. Egg, banana and oil are mixed and added to the previous mixture. Milk, cream, or other liquid-like substances are added to the mixture until it becomes thick, but not sticky. The resulting mixture is fried in oil (deep frying unnecessary) at moderate heat by turning fritters so they cook on both sides. The fritters are then removed, and drained, if desired. The resulting product may be eaten hot, cold, or with confectioner's sugar on top. The flour mixture (proportionally) may be added to make a dryer dough-like mixture for doughnuts, which may also be shaped and fried.

### Example 10

Vanilla Crescents

Ingredients:

14 oz butter
4 oz confectioner's sugar (powdered sugar)
2 tsp. vanilla extract
8 oz. Almond flour
14 oz cassava flour
10 oz plantain flour
   Method:

Butter, sugar and vanilla extract are mixed together. Almond, cassava, and plantain flours are mixed together and added to the previous mixture, shaped and baked at 325 degrees Fahrenheit.

### Example 11

Sweet Potato Chocolate Chip Cookies

Ingredients:

1 egg
1 stick (113 gms.) butter
15 gms. oil (optional)
12 gms. baking powder
1 cup or 190 gms. sweet potato flour
50 gms. plantain flour
75 gms. almond flour
165 gms. sugar
A dash cinnamon

The ingredients are mixed, shaped and baked at approx. 325 degrees Fahrenheit for about 15 minutes or as desired.

### Example 12

Banana Chocolate Chip Cookies

Ingredients:

1 egg
1 stick (113 g) butter
5 gms. oil (optional)
10 gms. baking powder
1½ cups or 136 gms. (4¾ oz) cassava flour
17 gms. banana flour
⅔ cup or 81 gms. (2⅞ oz) almond flour
⅔ cup or 186 gms. (6½ oz) gms. sugar
A dash cinnamon
2 dashes nutmeg

The ingredients are mixed, shaped and baked at approx. 325 degrees Fahrenheit for about 15 minutes or as desired.

### Example 13

Buckwheat Chocolate Chip Cookies

Ingredients:

1 egg
1 stick (113 gms.) butter
5 gms. oil (optional)
10 gms. baking powder
65 gms. cassava flour
65 gms. buckwheat flour
17 gms. plantain flour
⅔ cup or 81 gms. (2⅞ oz) almond flour
⅔ cup or 186 gms. (6½ oz) gms. sugar
A dash cinnamon
2 dashes nutmeg

The ingredients are mixed, shaped and baked at approx. 325 degrees Fahrenheit for about 15 minutes or as desired.

### Example 14

Maple Sugar Chocolate Chip Cookies

Ingredients:

1 egg
1 stick (113 gms.) butter
5 gms. oil (optional)
10 gms. baking powder
136 gms. cassava flour
17 gms. plantain flour
⅔ cup or 81 gms. (2⅞ oz) almond flour
⅔ cup or 186 gms. (6½ oz) gms. maple sugar
A dash cinnamon
2 dashes nutmeg

The ingredients are mixed, shaped and baked at approx. 325 degrees Fahrenheit for about 15 minutes or as desired.

### Example 15

Hazelnut Carrot Cup Cake

Ingredients:

1½ bananas
½ cup or approx. 56 gms. shredded carrot
150 gms. or 5¼ ounces hazelnut flour
100 gms. or 3½ oz cassava flour
75 gms. or 2⅝ oz plantain flour
80 gms. oil
2 eggs
15 g or ½ oz baking powder
240 gms. sugar
½ teaspoon nutmeg
¼ teaspoon cinnamon
50 gms. raisins

The ingredients are mixed, shaped and baked at approx. 320 degrees Fahrenheit for about 25-30 minutes or until cooked.

### Example 16

Banana and Plantain Chocolate Chip Cookies

Ingredients:

80 gms. cassava flour
50 gms. sweet potato flour
25 gms. plantain flour
5 gms. banana flour
80 gms. almond flour
1 stick (113g) butter
185 gms. sugar
A dash nutmeg
A dash cinnamon
12 gms. baking powder
1 egg

The ingredients are mixed, shaped and baked at approx. 325-350 degrees Fahrenheit for approximately 15 minutes.

While the foregoing invention has been described in some detail for purposes of clarity and understanding, it will be appreciated by one skilled in the art, from a reading of the disclosure, that various changes in form and detail can be made without departing from the true scope of the invention in the appended claims.

What is claimed is:

1. A composition containing less than about 20 ppm gluten comprising:
at least three ingredients, each ingredient having less than about 20 ppm gluten or no gluten, wherein the first ingredient is particles of dried cassava root, the second ingredient is particles of almond nuts, and the third ingredient is particles of dried plantain fruits.

2. The composition of claim 1, wherein the proportion of the first ingredient ranges from about 15% to about 85% by weight, the proportion of the second ingredient ranges from about 20% to about 80% by weight, and the proportion of the third ingredient ranges from about 5% to about 33% by weight of the total combined weight of the first, second and third ingredients.

3. The composition claim 1, wherein the proportion of the first ingredient ranges from about 55% to about 65% by weight, the proportion of the second ingredient ranges from about 40% to about 50% by weight, and the proportion of the third ingredient ranges from about 10% to about 20% by weight of the total combined weight of the first, second and third ingredients.

4. The composition of claim 1, wherein the ratio of the first, second, and third ingredients is approximately 8:5:1 by weight.

5. The composition of claim 1, wherein the ratio of the first, second, and third ingredients is approximately 2:1:1 by weight.

6. The composition of claim 1, wherein the composition is a kosher food product.

7. The composition of claim 1, wherein the composition is a bakery product.

8. The composition of claim 7, wherein the bakery product is a cookie.

9. The composition of claim 7, wherein the bakery product is a cake.

10. The composition of claim 1, wherein the composition is an uncooked ready-to-serve food product.

11. The composition of claim 1, wherein the composition is porridge.

12. The composition of claim 1, wherein the composition is a dough.

13. The composition of claim 1, wherein the composition is in colloidal form.

14. The composition of claim 1, wherein the dried cassava root is the whole root of cassava.

15. The composition of claim 1, wherein the dried cassava root is a root portion trimmed of outer skin, woody ends and inner core.

16. A composition containing less than about 20 ppm gluten, the composition comprising:
at least two ingredients, each ingredient having less than 20 ppm gluten wherein the first ingredient is particles of dried cassava root and the second ingredient is particles of plantain fruit, and wherein the proportion of the first ingredient ranges from about 50% to about 95% by weight of the total combined weight of both first and second ingredients and the proportion of the second ingredient ranges from about 5% to about 50% by weight of the total combined weight of both first and second ingredients.

17. The composition of claim 16 further comprising a third ingredient, wherein the third ingredient is particles of almond nuts, and wherein the proportion of the third ingredient ranges from about 5% to about 70% by weight of the total combined weight of the first and second ingredients or the total combined weight of the first, second and third ingredients.

18. A composition containing less than about 20 ppm gluten, the composition comprising:
at least three ingredients, wherein the first ingredient is particles of dried cassava root and the second ingredient is particles of almond nuts and the third ingredient is particles of dried plantain fruits, and wherein the proportion of the first ingredient ranges from about 15% to about 85% by weight, the proportion of the second ingredient ranges from about 20% to about 80% by weight, and the proportion of the third ingredient ranges from about 5% to about 33% by weight of the total combined weight of the first, second and third ingredients.

19. A gluten-free bakery product prepared from a dough, wherein the dough is made of at least three ingredients, wherein the first ingredient is particles of dried cassava root and the second ingredient is particles of almond nuts and the third ingredient is particles of dried plantain fruits, and wherein the proportion of the first ingredient ranges from about 15% to about 85% by weight, the proportion of the second ingredient ranges from about 20% to about 80% by weight, and the proportion of the third ingredient ranges from about 5% to about 33% by weight of the total combined weight of the first, second and third ingredients.

20. A method for making a food product, the food product containing less than 20 ppm gluten, the method comprising:
providing a first ingredient consisting of particles of dried cassava root;
providing a second ingredient consisting of particles of almond nuts; and
providing a third ingredient consisting of particles of dried plantain fruits.

21. The method of claim 18, wherein the proportion of the first ingredient ranges from about 15% to about 85% by weight, the proportion of the second ingredient ranges from about 20% to about 80% by weight, and the proportion of the third ingredient ranges from about 5% to about 33% by weight of the total combined weight of first, second and third ingredients.

22. The method of claim 20, wherein the proportion of the first ingredient ranges from about 55% to about 65% by weight, the proportion of the second ingredient ranges from about 40% to about 50% by weight, and the proportion of the third ingredient ranges from about 10% to about 20% by weight of the total combined weight of first, second and third ingredients.

23. The method of claim 20, wherein the food product is a kosher food product.

24. The method of claim 23, wherein the kosher food product is a Passover-specific kosher food product.

25. The method of claim 23, wherein the kosher food product is a Parve food product that excludes dairy-based ingredients.

26. The method of claim 20, wherein the food product is a bakery product.

27. The method of claim 26, wherein the bakery product is a cookie.

28. The method of claim 26, wherein the bakery product is a cake.

29. The method of claim 20, wherein the food product is an uncooked ready-to-serve food product.

30. The method of claim 20, wherein the food product is porridge.

31. The method of claim 20, wherein the food product is a dough.

32. The method of claim 20, wherein the food product is a coating mixture.

33. The method of claim 20, wherein the food product is in colloidal form.

34. The method of claim 33, wherein the food product is a paste.

35. The method of claim 33, wherein the food product is a cream.

36. The method claim 20, wherein the dried cassava root is the whole root of cassava.

37. The method of claim 20, wherein the dried cassava root is a root portion trimmed of outer skin, woody ends and inner core.

38. A method for making a food product containing less than 20 ppm gluten, the method comprising:
providing a first ingredient consisting of particles of dried cassava root;
providing a second ingredient consisting of particles of almond nuts; and
providing a third ingredient consisting of particles of dried plantain fruits,
wherein the proportion of the first ingredient ranges from about 15% to about 85% by weight, the proportion of the second ingredient ranges from about 20% to about 80% by weight, and the proportion of the third ingredient ranges from about 5% to about 33% by weight of the total combined weight of the first, second and third ingredients.

39. A method for manufacturing a composition containing less than 20 ppm gluten, the method comprising:
providing a first ingredient consisting of particles of dried cassava root;
providing a second ingredient consisting of particles of almond nuts; and
providing a third ingredient consisting of particles of dried plantain fruits,
wherein the proportion of the first ingredient ranges from about 15% to about 85% by weight, the proportion of the second ingredient ranges from about 20% to about 80% by weight, and the proportion of the third ingredient ranges from about 5% to about 33% by weight of the total combined weight of the first, second and third ingredients.

40. A composition containing less than about 20 ppm gluten, the composition comprising:
at least three ingredients, wherein the first ingredient is particles of dried cassava root and the second ingredient is particles of almond nuts and the third ingredient is particles of dried plantain fruits, and wherein the ratio of the first, second, and third ingredients is approximately 8:5:1 by weight.

41. A composition containing less than about 20 ppm gluten, the composition comprising:
at least three ingredients, wherein the first ingredient is particles of dried cassava root and the second ingredient is particles of almond nuts and the third ingredient is particles of dried plantain fruits, and wherein the ratio of the first, second, and third ingredients is approximately 2:1:1 by weight.

42. A composition containing less than about 20 ppm gluten comprising:
at least three ingredients, each ingredient having less than about 20 ppm gluten or no gluten, wherein the first ingredient is particles of dried roots of a root-tuber crop, the second ingredient is particles of dried nuts of a nut-tree, and the third ingredient is particles of dried fruits of a herbaceous tree in the Musaceae family.

43. The composition of claim 42, wherein the root-tuber crop is selected from a group consisting of cassava, sweet potato, yam and taro.

44. The composition of claim 42, wherein the nut-tree is selected from a group consisting of almond, hazelnut, pecan, walnut, pistachio, cashew and macadamia.

45. The composition of claim 42, wherein the herbaceous tree is selected from a group consisting of banana and plantain.

46. The composition of claim 42, further comprising a fourth ingredient, wherein the fourth ingredient is particles of dried seeds of buckwheat.

47. The composition of claim 42, further comprising a fourth ingredient, wherein the fourth ingredient is a maple sugar.

48. A method for making a food product, the food product containing less than 20 ppm gluten, the method comprising:
providing a first ingredient consisting of particles of dried roots of a root-tuber crop;
providing a second ingredient consisting of particles of dried nuts of a nut-tree; and
providing a third ingredient consisting of particles of dried fruits of a herbaceous tree in Musaceae family.

49. A composition containing less than about 20 ppm gluten comprising:
at least four ingredients, each ingredient having less than about 20 ppm gluten or no gluten, wherein the first ingredient is particles of dried roots of a root-tuber crop, the second ingredient is particles of dried nuts of a nut-tree, the third ingredient is particles of dried plantain fruits, and the fourth ingredient is particles of dried banana fruits.
